(19) United States
(12) Patent Application Publication
(10) Pub. No.: US 2017/0330117 A1
(43) Pub. Date: Nov. 16, 2017

(54) SYSTEM FOR AND METHOD FOR DETECTION OF INSIDER THREATS

(71) Applicant: THINKING SAFE LIMITED, Surrey (GB)

(72) Inventors: Julian Benedict DEAN, Egham (GB); Stephen GIBBS, Berkshire (GB); Pedros CONTRERAS, Greater London (GB)

(21) Appl. No.: 15/535,490

(22) PCT Filed: Dec. 15, 2015
(86) PCT No.: PCT/IB2015/059634

§ 371 Date: Jun. 13, 2017

(30) Foreign Application Priority Data
Dec. 15, 2014 (GB) 1422227.7

(51) Int. Cl. G06Q 10/06; G06N 7/00

(52) U.S. Cl. CPC G06Q 10/0635; G06N 7/005

(57) ABSTRACT

A system for predicting whether individuals are likely to participate in a specific activity which may represent a threat to an organization. A automated method predict threats by identifying psychological precursors related to the insider threat and assesses evidence of behavioural indicators associated with those psychological precursors. The system predicts insider threats from individuals DATA for indications psychological precursors of a class of insider threats is harvested to provide sets of indicator data associated with individuals. The indicator data sets are mapped to one or more psychological precursor data sets. The precursor data set(s) include(s) data indicative of the likelihood of an individual exhibiting a particular psychological precursor. A prediction of the likelihood of the individual being engaged in class or a specific class of insider threats, based on a psychological profile, is obtained by combining the psychological precursor data set(s).

### FIELD OF THE INVENTION

The present invention relates to a system for, and a method for, predicting whether one or more individuals is or is likely to participate in a specific activity, which represents a threat to an organisation. More particularly the invention relates to an automated method for predicting so-called insider threats by identifying psychological precursors of the insider threat and assessing the evidence of the behavioural indicators associated with those psychological precursors.

### BACKGROUND

In modern work environments, employees tend to spend an ever increasing amount of time interacting with and using computer systems. As a result, employees are increasingly exposed to sensitive information, and may be tempted to exploit that information for illegitimate purposes.

There is also an increased risk that changes in behaviour and/or capability of an employee will not be noticed, or if noticed may not be interpreted correctly or acted upon appropriately. In many cases, the organisation has insufficient resources and/or skills to assess the potential insider threat across all employees.

There is also significant change in the way people utilise technology, with the so-called millennial generation being more enthusiastic about information sharing through technological interaction than previous generations. This is a cultural change which results in both increased risk of threats as well as greater opportunities.

There is also a corresponding change in the way people understand information ownership, expectations of personal privacy and information security.

There are changes in the legal treatment of information ownership and access to information systems, but generally these changes are lagging behind technological advances of recent years, and consequently legislation is not always able to provide definitive guidance on many of these issues.

These changes present serious challenges for many organisations, which may not possess the necessary skills and experience to evaluate the risks, or may not have the human resources capacity to support the desired risk assessment in relation to all personnel.

The challenges for many organisations are further increased by the growing tendency of those organisations to outsource business functions, and for elements of those functions to be outsourced across an extended supply chain.

The above mentioned challenges are increased even further by the global nature of many businesses and dependency on global supply chains, leading sometimes to complications in the physical distribution and processing of relevant information; implications of legal jurisdiction under which information is stored and processed; and local, international and contract law relating to the duty of care expected from organisations participating within the supply chain.

The challenges of human resourcing for risk assessment may be significantly increased in cases where the assessment of risk needs to be extended beyond the employees of an organisation to include assessment of risk posed 30 by contractors, suppliers, customers, visitors and members of the public.

### PRIOR ART

U.S. Pat. No. 8,707,431 (The Mitre Corporation) relates to system which can be used to detect users who act on information to which they have access, but whose activity may not be appropriate or is out of character based on their identity, past activity, organizational context, and/or the information context. However, it does not identify psychological indicators associated with the source data, and it does not use those psychological indicators to predict behaviours that may represent a threat to the organisation.

Another system that examines computer activity is described in U.S. Pat. No. 8,589,328 (Symantec Corporation) which describes a system that examines computer user activity to assess user psychology. In one embodiment a method for examining computer user activity generates pattern data associated with internet activity. The pattern data is compared with human behaviour information. At least one processor identifies personality indicia that reflects at least one psychological trait. However, the aforementioned system does not examine or analyse email body content, or communications content captured from other sources. It is based solely on browsed pages, searched key words and downloads. In addition, the aforementioned system does not make any prediction about the future behaviour that may occur as a result of the psychological traits identified, and consequently cannot be used to provide automated response to potential insider threats.

U.S. Pat. No. 8,793,790 (Honeywell International Inc) describes a system and method for detecting insider threats which obtains data related to accessing cyber assets and accessing physical assets from a combined cyber access and physical access control system that protects assets of an organization from malicious intent. This solution compares data derived from known patterns of expected behaviour, and identify patterns of suspicious behaviour. The comparison is utilized to identify potentially malicious insider behaviour towards cyber and physical assets. The system uses data related to access control system from cyber or physical assets.

U.S. Pat. No. 8,799,462 (Bank Of America Corporation) describes a computer readable media, and apparatuses configured to calculate threat ratings. Aspects of the invention relate to computer implemented methods that form a predictive threat rating for individuals. The individuals may be members of an organization, such as a corporation or business entity. In one embodiment, the predictive rating is calculated for employees of an organization.

US Patent Application US-A1-2011/0225650 (Accenture Global Services Limited) discloses a method for detecting insider fraud. One method includes identifying one or more insider threat detection rules for an enterprise and obtaining behavioural data for an enterprise insider from multiple behavioural data sources.

US Patent Application US-A1-2014/0377727 (Microsoft Corporation) monitors user behaviour on a computerized device for any deviation from normal or acceptable behaviour that is likely to affect the user's mental state. A prediction model corresponding to features of one or more mental states may be compared with features based upon current user behaviour. If behaviour of a user presents a mental state indicative of an uncharacteristic deviation from the normal or acceptable behaviour, descriptive data associated with that mental state may be presented to the user or a health care professional.

Another example of a system for obtaining data indicative of mental state is described in US Patent Application US-A1-2014/031944 (EmoPulse, Inc) which discloses a system and method for obtaining and using user physiological and emotional data. One embodiment includes a wearable user device in the form of a first arm extending from a central body portion to a first-arm end. The device may also include a second arm extending from the central body portion and a concave cavity defined by the first and second arm and the central portion and configured to be worn on an elongated part of a body.

Information Security Officers have expressed interest in a system that detects symptomatic behaviour that is indicative of psychological states or conditions and consequently predictive of undesirable activities that represent an insider threat, in order that they can take pre-emptive action or intervention. Such pre-emptive intervention is intended to limit exposure of an organisation and reduce the risk of legal culpability of the organisation in cases where there is a risk of a security breach.

Information Security Officers are likely to be particularly interested in early prediction of activities based on psychological profiling, because it provides detection in a greater variety of specific circumstances and supports early intervention and consequently reduces risk and reduces financial, reputational and human costs.

It is well known that stress in the workplace can lead to acts of violence against others, inappropriate acts of physical and verbal aggression, or a range of other civil and criminal offences.

It is also well known that depression in the workplace can lead to long-term sick leave, absenteeism, poor performance, and negative emotional impact on co-workers and in worse case scenarios sometime even to suicide. Also people suffering from depression or low self-esteem might present as opportunities for radicalisation, coercion or blackmail.

Demotivation in the workplace can lead to employees to resign, as well as increased absenteeism, reduced performance, petty theft, unauthorised sharing or deletion or modification of information.

Many Information Security Officers are interested in predicting the risk of insider threat based on psychological factors, because prediction based on psychology is likely to identify underlying causes of the threat, and should consequently be able to predict a wider range of threats.

Some organisations are interested in predicting the potential for social engineering attacks, where vulnerable people may be compromised as part of a broader attack.

Some organisations are specifically interested in predicting the risk of theft, destruction, corruption or abuse of information and/or property.

Some organisations, including law enforcement authorities, are interested in predicting fraud or conspiracy to commit fraud.

An aim of the invention is to overcome disadvantages associated with the aforementioned systems.

Another aim is to provide a system and a method for predicting whether one or more individuals is or is likely to participate in a specific activity, which represents a threat to an organisation.

A third aim is to establish whether an individual is subject to coercion or corruption as a result of their psychological state, possibly in combination with other factors.

### SUMMARY OF THE INVENTION

According to a first aspect of the present invention there is provided a system for predicting insider threats from one or more individuals, the system comprises: a means for harvesting data indicative of psychological precursors of a class of insider threats from one or more data sources; a processor for processing the harvested data to provide one or more sets of indicator data associated with one or more individuals; a mapping means maps the indicator data sets to one or more psychological precursor data sets, the precursor data set(s) including data indicative of the likelihood of an individual exhibiting a particular psychological precursor; and a means for generating a prediction of the likelihood of the individual being engaged in a specific class of insider threats based on a psychological profile obtained by combining the psychological precursor data set(s).

An important difference between what is disclosed in U.S. Pat. No. 8,707,431, for example, and the present invention is that the present invention examines and applies linguistic analysis to the communication content (such as email body) which establishes the causal link between specific observable behaviours and the psychological precursors.

The system described in U.S. Pat. No. 8,589,328 uses pattern data to forecast human behaviour, whereas the present invention focuses on insider threats for which psychology traits and personality patterns are some of the inputs. Therefore for example the present invention uses additional information sources such as data from other sources, such as emails and data provided from a human resource (HR) database system that includes data relating to holidays, paternity leave, sickness leave and punctuality.

According to another aspect of the present invention there is provided a method of detecting an insider threat based on email communications, comprising: collecting psychological indicators by accessing a plurality of emails sent from a given target user device; determining a number of aggressive words in each of said plurality of emails; determining a number of first-person singular pronouns in each of said plurality of emails; determining a number of second-person pronouns in each of said plurality of emails; determining a number of first-person plural pronouns in each of said plurality of emails; determining a number of said plurality of emails sent by said given target user device; and determining a number of social connections indicated by said plurality of emails sent; wherein a psychological precursor to a user of said given target user device is obtained based on a correlation of said number of aggressive words, said number of first-person singular pronouns, said number of second-person pronouns, said number of first-person plural pronouns, said number of said plurality of emails sent, and said number of social connections indicated by said plurality of emails.

It will be appreciated that the invention also provides a system for performing all aspects of the aforementioned methods and that the preferred features of the methods may also be included in the systems and performed by a combination of software and hardware devices.

The prior art systems do not include evidence based from behavioural theory nor do they examine or analyse email body content.

In the system described in U.S. Pat. No. 8,793,790 a model of expected behaviour is built based directly on observable behaviours. This is different from the present invention in which the prediction of future behaviour is based on analysing source data for evidence of psychological precursors, which are known to be associated with the predicted behaviours as a result of psychological and behavioural science research.

In accordance with another aspect of the invention there is provided a computer implemented method for predicting the insider threats behaviour of from one or more individuals, the method comprising: harvesting data indicative of psychological precursors of an activity or a behaviour of interest or a class of insider threats from one or more data sources; processing the harvested data to provide one or more sets of indicator data associated with one or more individuals; mapping the indicator data sets to one or more psychological precursor data sets, the precursor data set(s) including data indicative of the likelihood of an individual exhibiting a particular psychological precursor; and generating a prediction of the likelihood of the individual exhibiting the behaviour of interest being engaged in the class of a specific class of insider threats based on a psychological profile obtained by combining the psychological precursor data set(s).

For many organisations there is a legal duty of care to monitor and protect employee health and well-being, and permission based acceptance of such monitoring and protection may be an important first stage in establishing effective insider threat detection systems, as they can be used to establish just cause for more selective or invasive investigation of individuals who are potentially at risk.

In some organisations there is a legal duty of care and moral responsibility to protect employees from acts of coercion, which may be detrimental to the health and well-being of the employee or their family and friends. Identification of behaviour that is inconsistent with the normal psychological profile of the individual, and particularly behaviours that are consistent with the psychology of coercion, may be very relevant in detecting signs of a broader attack.

For other organisations there is a legal duty of care and moral responsibility to protect the public from inappropriate actions by a disgruntled employee or ex-employee. This may be incidental to the primary aim of protecting the organisation from attack, or may be a core component of the mission.

Another important difference between what is taught in U.S. Pat. No. 8,589,328 and the present invention is that the prior art system only assesses user psychology, based on analysis of a person's internet usage; whereas the present invention analyses human psychology based on any observable behaviour that can be associated with an individual, including some types of behaviour that may only be observable via computers that an individual does not have direct interaction with or use themselves.

Furthermore some prior art systems tend only to assess user psychology based on the occurrence of predetermined keywords; whereas the present invention analyses human psychology based on any observable behaviour, including complex semantic analysis of the content and non-linguistic behaviours, such as posture or transition between visually displayed windows.

Another important difference between the present invention and many prior art systems is that some existing techniques only assess user psychology based on user activity that are indicative of a specific psychological characteristic; whereas the present invention analyses human psychology based on the presence and/or absence of observable behaviours, as well as the proportion of one observable behaviour to another observable behaviour.

Some existing systems are intended to provide a psychological report on the user of a specific computer. This is often based on the internet browsing activity of that user. The present invention system is designed to provide a psychological report on any human, based on observable behaviour that can be associated with them, regardless of the location of the observation.

Another important difference is that some systems identify user psychology based on simple patterns, such as the occurrence of pre-configured keywords. The present invention divides this process into two distinct stages: the first stage includes simple pattern analysis; and the second stage evaluates the evidence collected in the first stage in order to establish patterns within the patterns (or meta-patterns) that are indicative of specific psychological characteristic.

There are legal, ethical, moral, social and technical considerations, which must be taken into account when considering collection of information to support the creation of personally identifiable personality profiles and predictions of future behaviour.

However, it is reasonable to assert that the benefits of such psychological profiling to employees, employers and society in general are significant.

In some circumstances, the information collected, transmitted, stored and processed by the insider threat detection system may be even more sensitive than the information processed by the individual in the course of their work.

Aggregation of information across a population of individuals is very likely to increase the security classification and sensitivity of the information processed.

The distribution of information storage and processing across a network of computers will have significant impact on the attack surface of the insider threat detection system, so modularity and distribution of the solution is very important from a security perspective.

The system may be deployed proactively to identify insider threats before they occur, but it can also be deployed retrospectively to provide forensic analysis of the individual psychological profiles, such as meta-data, across a selected population for a selected time interval, in order to prioritise individuals of potential interest.

According to another aspect of the present invention, there is provided a method for predicting the risk of whether an individual is likely to participate in a threat related activity, the method comprising: identifying psychological precursors to the specific activity, with reference to recognised academic research; identifying known behavioural indicators associated with the specific psychological precursors, with reference to recognised academic research; identifying relevant technical methods for collection and extraction of the behavioural indicators from available data sources; collecting the source data from which behavioural indicators may be extracted and monitoring physical and social networks.

According to further aspects of the invention there is provided systems for performing the aforementioned methods.

Collection of data from data sources, includes sources such as closed circuit television (CCTV), video and sound recording, location and acceleration recording, monitoring of electronic communications and computer systems usage, environmental monitoring. The collection process may include technical transformation, such as compression and/or encryption and/or anonymization of the source data, for example in order to reduce the total volume of data to be processed or for security reasons or for legal reasons.

Optionally removal of certain elements or classes of data may take place, including removal of non-relevant artefacts within the data. Alternatively amplification of artefacts of relevance may be applied to the data.

Ideally the system and method performs extraction of behavioural indicators by processing the source data and by use of appropriate mathematical and computational methods. These methods may include automatic transcription of verbal communications, linguistic and social analysis of communications, counting occurrences of events that support or contradict one or more behaviour indicators, applying moderators to the evidence, and combining the evidence using mathematical or computational methods.

Ideally an assessment of the evidence for the psychological precursors within a specific individual is derived by analysing the behavioural indicators of those psychological precursors using statistics, probability, calculus, rule-based systems, and/or machine learning, in order to create a prediction about whether an individual is likely to participate in the specific activity of interest, and then analysing the relative likelihood of individuals within a population participating in the activity of interest.

Optionally there is an assessment and implementation of an appropriate response to the prediction of activities of interest. This may include simple notification, adding an individual to a database, automating a response to effect the environment of the individual, or triggering more sophisticated assessment of the individual, in relation to other predictions or external information.

One or more of the data sources may provide information in real time, and the method for reducing the volume of data to be processed and extracting relevant artefacts from the data may be carried out in real time, or the method may be carried out on stored data that has been archived over a period of weeks, months or even years.

One or more of the indicator collection engines may provide pre-processed information in real time, or they may provide access to stored data that has been archived over a period of weeks, months or even years.

One or more of the indicator collection engines may be distributed across multiple geographic locations, and the data processing and data storage performed by the collector may be distributed across multiple geographic locations.

One or more of the psychological precursor detection engines may process information in real time, or the method may be carried out on stored data that has been archived over a period of weeks, months or even years.

One or more of the psychological precursor detection engines may be distributed across multiple geographic locations, and the data processing and data storage performed by the detector may be distributed across multiple geographic locations.

One or more of the psychological precursor detection engines may process information in real time, or the method may be carried out on stored data that has been archived over a period of weeks, months or even years.

One or more of the activity prediction engines may be distributed across multiple geographic locations, and the data analysis and intermediate data storage performed by the predictor may be distributed across multiple geographic locations.

One or more of the response engines may be distributed across multiple geographic locations, and the analysis and actions performed by the response engine may be distributed across multiple geographic locations.

The system and method preferably assess the psychological behaviour of one or more individuals during their normal work based activity using several data source(s) without requiring the individuals to perform any specific tasks. As a result, the method can be considered as a passively operating system, that is used to accurately assess the psychological profile of the individuals and make predictions about the future activities of the individuals without necessarily bringing the assessment to the attention of the individuals.

The data sources are preferably in direct communication with a computer system or network of computer systems. The data sources may be selected from one or more of: a laptop, a personal computer (PC), a computer server, a local or remote computer service, a cloud service, a tablet, a smartphone, industrial machinery or control systems, robotic equipment, office or domestic machinery or control systems, environmental control systems, environmental monitoring systems (CCTV, video, sound, vibration, and chemical detection sensors), electronic communications equipment, or any other source of digital data.

Sources of data include inputs from one or more of: a web based graphical user interface, any other human or machine interface, an email, a short messaging system (SMS) notification, voice communications, videoconference communications or combinations thereof.

The method may further comprise: activating one or more actuation mechanisms. The actuation mechanisms are preferably activated in order to prevent, restrict or discourage an individual from pursing activities that are considered to be undesirable.

An actuation mechanism may for example enable the individual to be disconnected from a data source, subjected to additional usage controls, prevented from accessing sensitive functionality, switch off a power supply to the data source, send emails to a supervisor or line manager raising awareness of the increased risk, automatically restrict access to one or more specified data sources or systems and/or log changes of capability or access authority of a particular individual or group of individuals.

One or more psychological precursors may be selected including: stress levels, aggression levels, and feelings of isolation, or any combination thereof.

The data indicative of psychological precursors may comprise raw data, such as: key strokes per minute or number of task screens (windows) which might be open at any one time, which indicate activity of an individual at a terminal at any specific instant.

Other forms of data may be used including: data that may be processed to extract behavioural indicators of the psychological precursors of the activity of interest, which may be selected from one or more of: email content, GPS meta data, biometric data, closed circuit television (CCTV), voice transcripts, infrastructure data and data obtained from digital sensors and third party systems (such as cash points or point-of-sale payment terminals in supermarkets) or other environmental metrics for example from hospitals, healthcare authorities or law enforcement sources; or any combination thereof.

The system and method may further comprise storing the harvested data in a data storage module for subsequent processing or historical comparison purposes or for secure archiving. Storage may be subjected to encryption of data for security purposes.

The indicator data set(s) may be manipulated through the incorporation of at least one algorithm to determine anomalies in one or more of the behavioural indicators of the psychological precursors of the activity of interest corresponding to the individual.

The precursor data set(s) may be manipulated through the incorporation of at least one algorithm to determine anomalies in one or more psychological precursors of the activity of interest corresponding to the individual.

According to another aspect of the invention there is provided a database management system comprising: a means for obtaining data and associating a risk with the data; a means for ranking the risks and associated data; and a means for generating a prioritisation rule which when one or more predefined threshold criteria are exceeded a trigger is generated which confines or restricts activity of an individual according to a predefined set of instructions.

The restriction of activity may include restriction of an access right or right to perform certain tasks or editorial permission or some other user right or permission.

Environmental data may be overlaid or combined with other source data in order to derive an holistic view of the individual.

A preferred embodiment of the invention is now described by way of example only and with reference to the Figures in which:

### BRIEF DESCRIPTION OF FIGURES

FIG. 1 shows an overall diagrammatical view of a plausible deployment of the system for predicting specific activities within a distributed population of individuals;

FIG. 2 is a block diagram showing how information flows in one embodiment of the present invention which predicts specific activities within a population of individuals and a related method;

FIG. 3 shows a detailed block diagram for the indicator collection engine as shown in FIG. 1;

FIG. 4 shows a detailed block diagram for the psychological precursor detection engine as shown in FIG. 1;

FIG. 5 shows a detailed block diagram for the activity prediction engine;

FIG. 6 shows a detailed block diagram for the response engine;

FIGS. 7 and 8 are diagrammatic illustrations of a scenario in which the present invention may be deployed; and

FIGS. 9 and 10 show graphical examples of how an insider threat detection system displays statistical correlations for indicating insider threat risk.

### DETAILED DESCRIPTION OF PREFERRED EMBODIMENT OF THE INVENTION

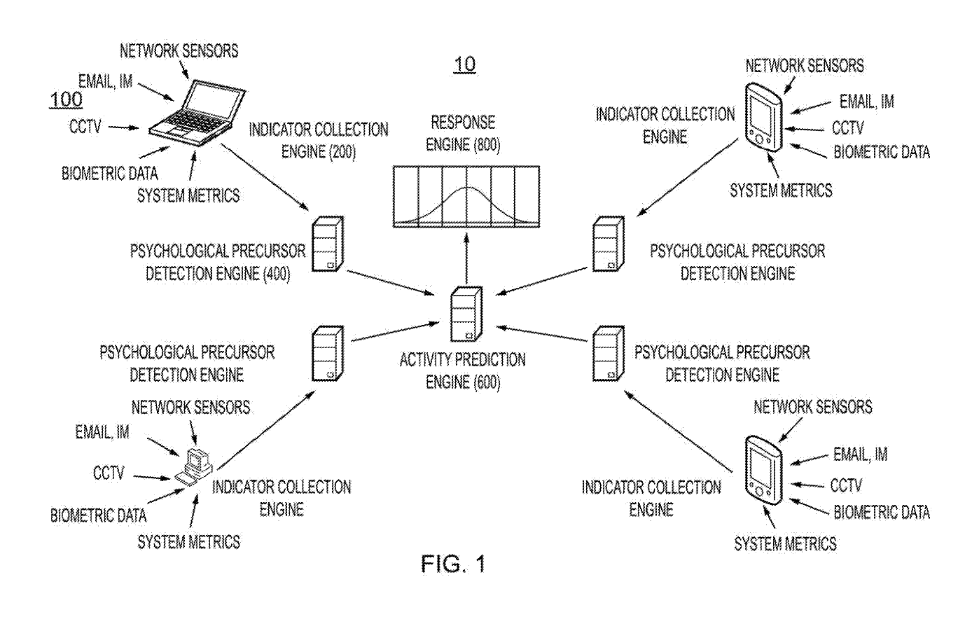

With reference to FIG. 1, the overall system 10 comprises four indicator collectors 200. Each indicator collector 200 is associated with multiple data sources 100. It is to be understood that the system 10 may comprise any suitable number of indicator collectors 200 and each indicator collector may be associated with any suitable number of data sources 100 in use with the overall system 10.

Although the FIG. 1 shows the indicator collection engines 200 as comprising a laptop, a PC, a tablet and a mobile phone, and the data sources 100 comprising network sensors, email, instant messaging, CCTV, biometric data, and system metrics, it is to be understood that the system 10 may comprise any number and combination of suitable electronic devices that implement the functionality of the indicator collection engine 200 and data sources 100 and is not limited to the types of devices and data sources shown in the Figures.

Each indicator collector 200 harvests data indicative of psychological behaviour from the associated data source 100. The harvested data is processed and each indicator collector 200 produces indicator data 300 from the corresponding data source 100.

The indicator collectors 200 may extract relevant information from the data source(s) 100. The collector 200 may extract raw data from the data source(s). The relevant information may include information from emails and other sources, such as for example word processing documents, GPS, voice transcripts, infrastructure data and sensors, or any combination thereof. The indicator collectors 200 may monitor the number and/or types of programs being used at a given time by the individual.

For example, the data source 100 may specify that the individual has a number of software programs open at the same time, may have multiple documents within the same program open, or contain a number of draft emails which have yet to be sent. This may be indicative of an individual struggling to cope with the work tasks and feeling stressed.

The indicator collection engine 200 may use a data transformation engine 201 to extract relevant information from the data source(s) 100 and convert the data into a format that can be used by a feature detection engine 202. Although the collector 200 for each type of data source 100 will be different the information obtained from each data source 100 may be converted into a standard format before output.

This harvested data may be optionally stored in a data storage module. Storage of the data enables the raw data associated with a data source 100 to be reviewed at a later date once the corresponding user has been identified as presenting a potential risk.

The overall system 10 further comprises four psychological precursor detection engines 400. It is to be understood that the system 10 may comprise any suitable number of psychological precursor detection engines 400. Each psychological precursor detection engine 400 is associated with one or more corresponding indicator collection engines 200. Each psychological precursor detection engine 400 receives the indicator data 300 from the corresponding indicator collection engine 200. Each detector 400 may receive indicator data 300 from multiple collectors 200. Each detector 400 may use a data transformation engine 401 to convert the data into a format that can be used by a feature detection engine 402 if necessary.

Each psychological precursor detection engine 400 maps the indicator data 300 to linguistic, social science and psychological research data which identify psychological precursors. Examples of psychological precursors include, but are not limited to, stress, aggression and isolation, and any combination thereof. Each psychological precursor detector 400 provides precursor data, which identifies the likelihood of the psychological precursor being satisfied for a specific individual 500.

The linguistic, social science and psychological research data may be stored within the psychological precursor detectors 400. The data may be stored on a data storage module within the detectors 404. The psychological research data stored on the module may be updated and used to re-process the indicator data 300 at any time. Furthermore, new software module plug-ins may be added to the detectors 400 in order to enable the detectors 400 to detect different psychological precursors or detect the same psychological precursors using different mechanisms or based on different research data.

The activity prediction engine 600 creates a mapping from the precursor data 500 to the prediction data 700. The prediction engine 600 may include a data transformation engine 601, psychological analysis engine 602, baseline and scaling analysis module 603, user population analysis module 604 and prediction data storage module 605.

The system 10 further comprises a response engine 800. The response engine 800 receives the prediction data 700 produced by each of the psychological precursor detectors 600. Each response engine 700 may receive prediction data 700 from multiple precursor detectors 600.

Each response engine 800 may include a communication module 801 and an activation module 802. The communication module 801 may advise relevant people of the prediction data 900 generated by the activity prediction engine, and the activation module 802 may generate physical actions in the real world, such as changing the physical access authorisation for the individual.

The method of the present invention may be used to monitor and/or detect individuals, such as for example employees, who may be demonstrating early warning signals, in particular psychological signs, of carrying out activities which are considered to be detrimental to the organisation, such as for example insider trading activity or fraud.

The method of the present invention enables the psychological profile of one or more individuals to be analysed, for example in a real-time basis, within the normal working environment. The method of the present invention enables the psychological behaviour of one or more individuals to be monitored discreetly without alerting the individual to the assessment. The method of the present invention may be used to continuously monitor the psychological profile of the individual(s).

Alternatively, the method of the present invention may be used at regular intervals, or at random intervals, to assess the psychological profile of the individual(s).

### Example I

Example embodiment for predicting fraud by processing email data sources, which contain the email body of all communications produced by each individual

Indicator Collector Engine

An email collector can be designed to periodically check new emails. In this case we are interested in the behaviour of a given individual for example only Items sent by them are to be considered. As new emails are discovered the collector extracts the email indicators that are of potential interest.

Processing data from emails the following indicators are able to be generated:

Number of aggressive words (indicator of anger/aggression).

Number of first-person singular pronouns (indicator of disengagement/isolation).

Number of second-person pronouns (indicator of disengagement/isolation).

Number of first-person plural pronouns (indicator of disengagement/isolation).

Number of emails sent (indicator of disengagement/isolation).

Social connections, e.g. who is emailing who (indicator of disengagement/isolation).

Indicators of this kind are mapped to a precursor. For example, within psychology it is well understood that aggression, disengagement and isolation are behavioural precursors that can explain an insider threat.

The indicator collection engine includes tasks such performing dictionary searches in the email body for certain words. Each email is scanned for any of these words and the total number are stored as part of the raw data indicator.

Psychological Precursor Detector Engine

The email Psychological Precursor Detection Engine takes the indicator data and performs calculations on it to arrive at a value for each of the indicators. Each indicator is defined as x and the whole indicator set as X.

A precursor is defined as p and the whole set of precursors as P.

An example of a Psychological Precursor Detection Engine can be as follows:

$${p}_{i} = \frac{{x}_{1} \cdot {w}_{1} + {x}_{2} \cdot {w}_{2} + … + {x}_{n} \cdot {w}_{n}}{\text{?}} = \frac{{\sum }_{i}^{n} {x}_{i} \cdot {w}_{i}}{\text{?}} \\ \text{?} \text{indicates text missing or illegible when filed} \qquad ( 1 )$$

where pᵢ is the i-th precursor; xᵢ is the i-th indicator; wᵢ is the weight associate to each indicator xᵢ; and Σᵢ^{m}wᵢ=1.

Activity Prediction Engine

The Activity Prediction Engine takes the precursor data and analyses it.

An example of an Activity Prediction Engine can be as follows:

$${a}_{i} = \frac{{p}_{1} \cdot {w}_{1} + {p}_{2} \cdot {w}_{2} + … + {p}_{n} \cdot {w}_{n}}{\text{?}} = \frac{{\sum }_{i}^{n} {p}_{i} \cdot {w}_{i}}{\text{?}} \\ \text{?} \text{indicates text missing or illegible when filed} \qquad ( 2 )$$

where aᵢ is the i-th activity predictor; pᵢ is the i-th precursor; wᵢ is the weight associate to each precursor xᵢ; and Σᵢ^{m}wᵢ=1.

Then the engine looks for changes when compared to a base line. In other words we compare against historical behavioural data to see if there is any change. In this instance a statistical method based on the Gaussian distribution can be used.

A baseline consisting of the values representing the key behavioural precursors that represent the normal behaviour of each individual is created.

A particular representation of this is the use of a Gaussian distribution to determine a baseline. Then use it in order to identify future deviations from the “normal behaviour”. A machine learning algorithm or neural network can also be used in this step.

If a change in behaviour is detected then a flag is set, which can be associated to a risk score.

A metrics used to flag behaviour can include the following:

As measure of central tendency we use the arithmetic mean defined as:

$$μ = \frac{1}{n} \text{?} {x}_{i} \\ \text{?} \text{indicates text missing or illegible when filed} \qquad ( 3 )$$

where n is the number of values and xᵢ represent each value.

In order to measure variation and data dispersion from the averages we use the standard deviation and variance, which are defined as:

$$σ = \sqrt{\text{?}} \\ \text{?} \text{indicates text missing or illegible when filed} \qquad ( 4 )$$

where xᵢ represents each value in the population, μ the mean value of the population, and n is the number of values in the population.

Variance:

$${σ}^{2} = \frac{{\sum }_{i = 1}^{n} {( {x}_{i} - μ )}^{2}}{n} \qquad ( 5 )$$

where xᵢ represents each value in the population, μ the mean value of the population, and n is the number of values in the population.

In this case the criterion would be to flag behavioural activities represented by precursors when they fall outside of mean plus/minus two standard deviations.

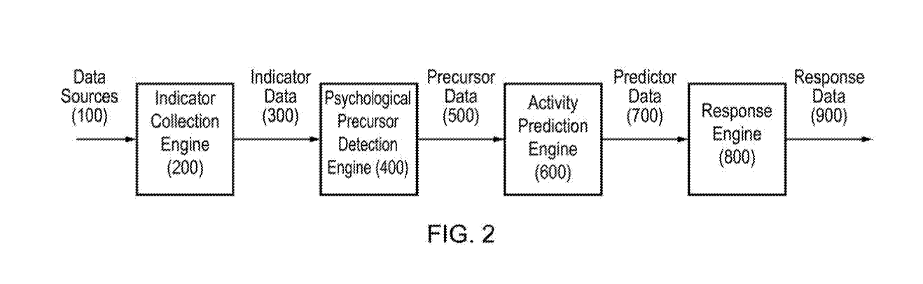

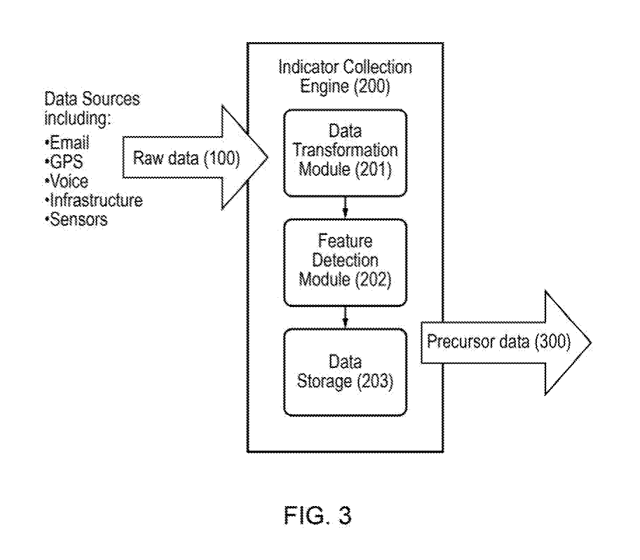

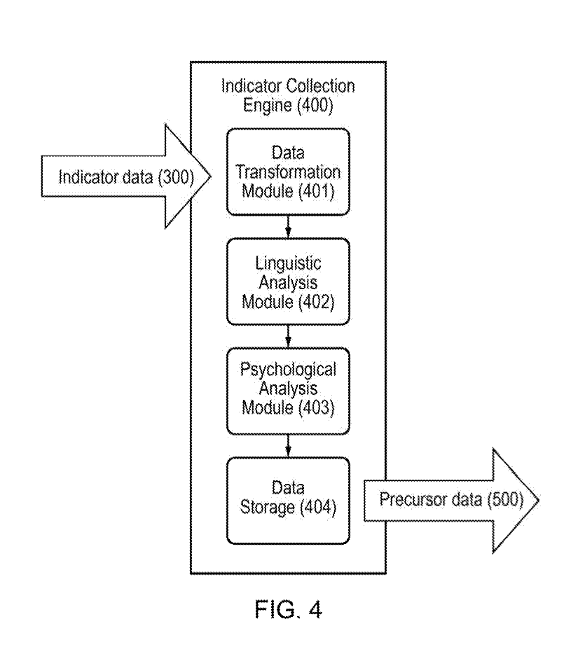

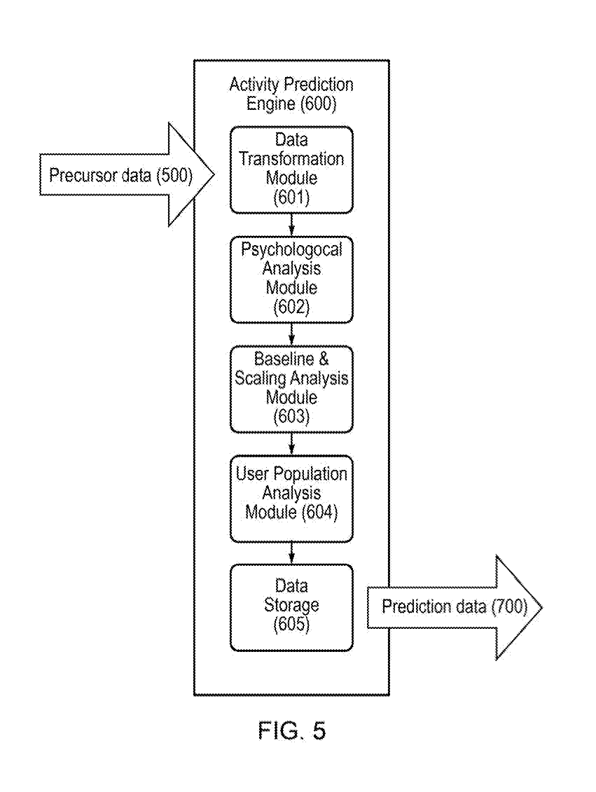

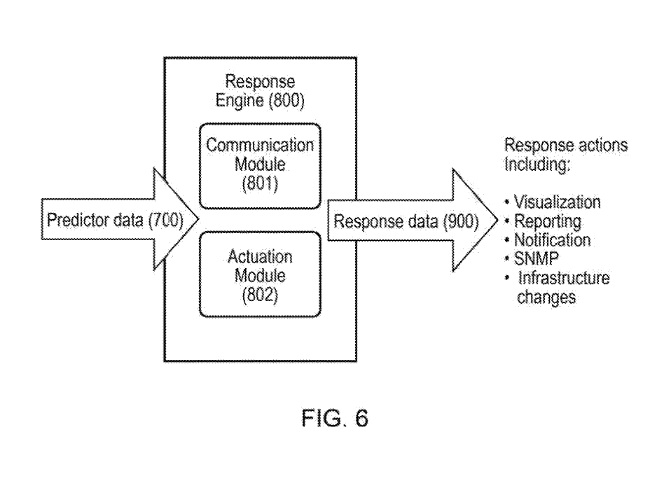

There is now described an example embodiment for making activity predictions by processing multiple distributed data sources. Referring to the Figures and in particular FIG. 2, as a deployment example a distributed approach is employed in which the psychological precursor detection engine 400 and the activity prediction engine 600 run on different distributed secure appliances. The secure nature of this deployment is a critical aspect of the system as the nature of the data that is being exchanged is typically sensitive.

The data that describes the behavioural indicators is collected by the indicator collection engines (200) that are deployed on devices such as laptops, tablets, personal computers and smartphones (see above example). The types of data collected may vary depending on the deployment scenarios but in the presented example data from the group: a) network sensors, b) CCTV feeds, c) Natural Language Processing including emails and IM (instant messaging), d) biometric data and e) system environment metrics (e.g. USB drive usage or number of windows open at any time) are all gathered and may be used collectively or as sub-groups of data sets.

Each endpoint device passes the collected data to a psychological precursor detection engine (400) that is run on a networked secure appliance using a secure connection. In the presented example there is a one to one relationship between indicator collection 200 and psychological precursor detection engines 400.

In the above example it is understood that a centralized activity prediction engine 600 processes psychological precursor data 500 from multiple psychological precursor detection engines 400. In this embodiment the centralization allows for the processing of data from a variety of sources (detectors) in order to enable the reporting and visualization of the whole network by the response engine 800. The proposed distributed deployment of this example ensures that potentially intensive functionality in terms of processing and memory usage is distributed among multiple secure appliances within a secure distributed environment.

Another way in which the system may be employed is to install the psychological precursor detection engine 400 and the activity prediction engine on the same secure appliance. This would eliminate the requirement for a secure link between the two layers of processing as they will be taking place on the same appliance. A disadvantage to this approach is the requirement for expensive processing from the same device. The system designer should take into account the above trade off when deploying the proposed system.

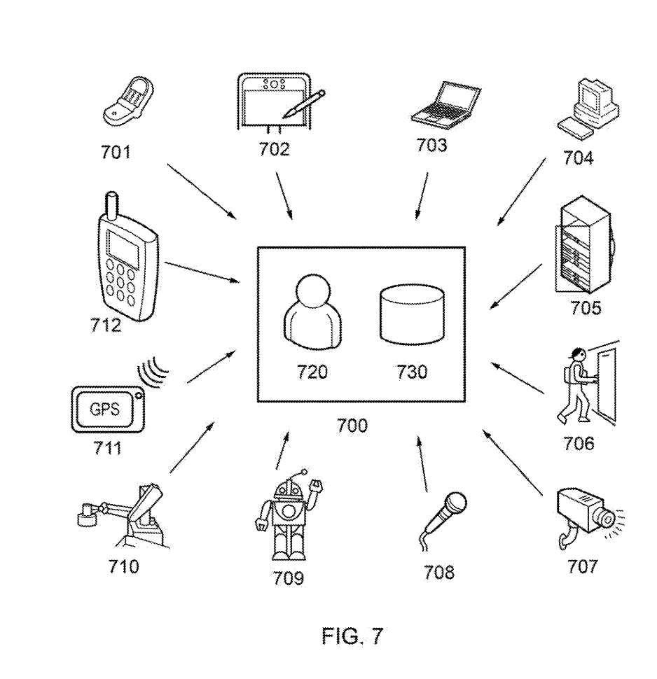

FIG. 7 shows an example of an insider threat detection system 700 that collects information about the behaviour of the individual 720 and stores it as data 730, from a number of external systems including: mobile phones 701, tablet computers 702, laptop computers 703, desktop computers 704, computer server systems 705, access control systems 706, CCTV camera systems 707, sound and vibration recording systems 708, robotic systems 709, industrial automation systems 710, global positioning systems 711, and radio and sensor systems 712.

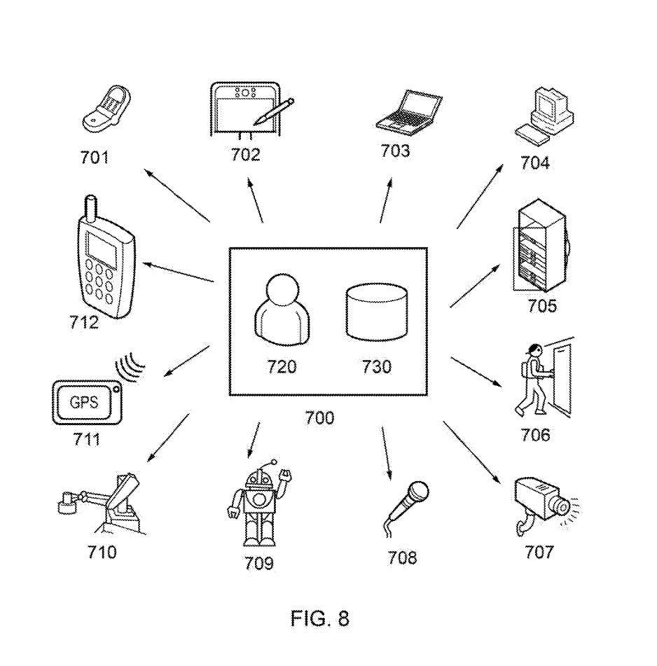

FIG. 8 shows another example of an insider threat detection system, in which like parts bear the same reference numerals as FIG. 7. Insider threat detection system 700 can also actuate a response to insider threat predictions about individual 720 based upon the data 730, within a number of external systems including: mobile phones 701, tablet computers 702, laptop computers 703, desktop computers 704, computer server systems 705, access control systems 706, CCTV camera systems 707, sound and vibration recording systems 708, robotic systems 709, industrial automation systems 710, global positioning systems 711, and radio and sensor systems 712.

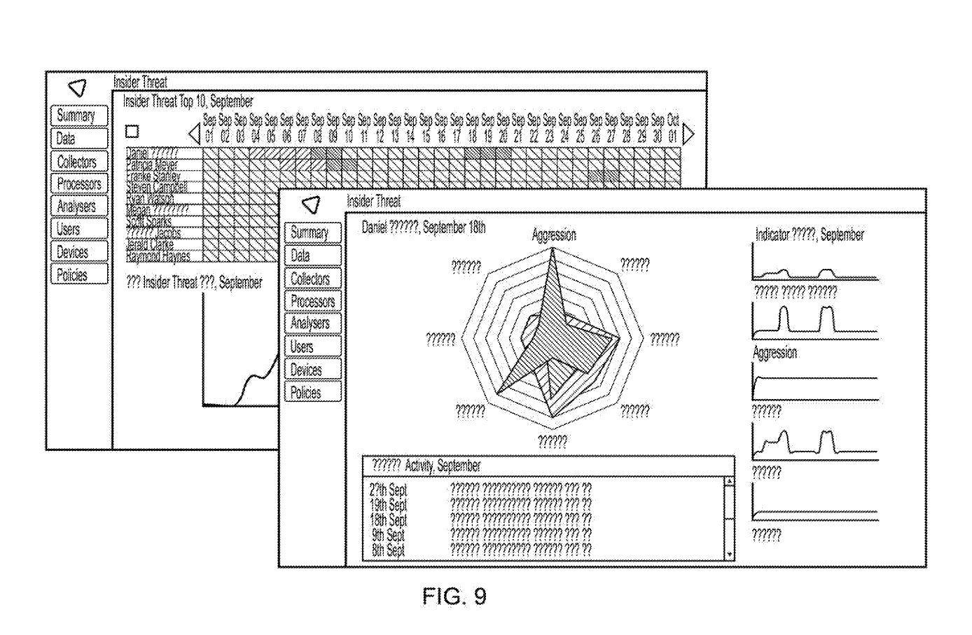

FIG. 9 shows how an insider threat detection system 700 displays the insider threat assessment for each individual 720 for every date and time, and the threat assessments can be sorted to show the most serious and/or imminent threats at the top. The insider threat detection system 700 can display the psychological profile for the individual 720 at a specific date and time, and can also display the normal behaviour of the individual 720 over a configurable period of time, for comparison purposes.

Insider threat detection system 700 can display psychological profile for the individual 720 over a period of time, by showing elements of the profile on separate graphs.

Insider threat detection system 700 can display a natural language narrative about the changes in the psychological profile for the individual 720 over a period of time, allowing the narrative to be compared with other time-based information sources.

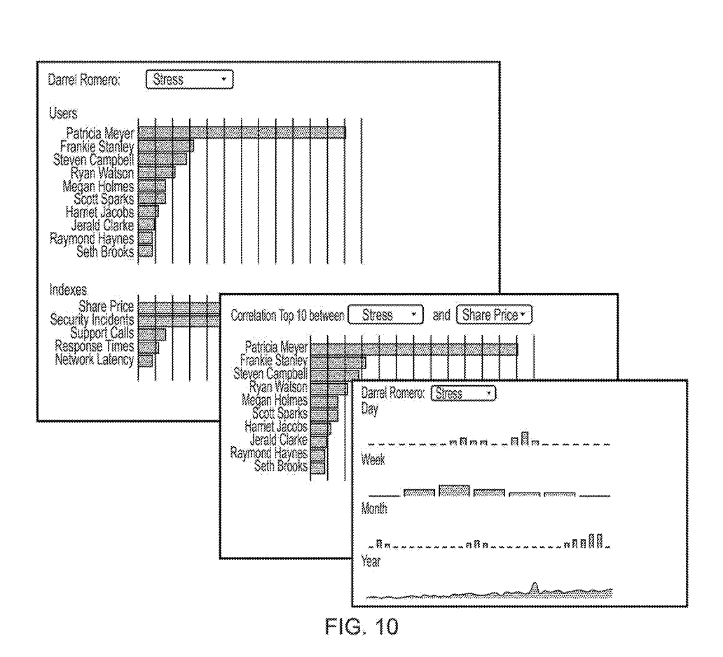

Referring now to FIG. 10, there is shown another example of how an insider threat detection system 700 can display the statistical correlation between psychological profiles of multiple individuals 720 over a period of time, and/or display the statistical correlation between elements of the psychological profiles of multiple individuals 720 over a period of time.

Insider threat detection system 700 can also display the statistical correlation between psychological profile an individual 720 and any external information source, such as the share price of the company, number of security incidents, number of support calls, response times, or network latency.

Insider threat detection system 700 can also display the statistical correlation between psychological profile multiple individuals 720 and any external information source, such as the share price of the company, number of security incidents, number of support calls, response times, or network latency.

Insider threat detection system 700 can also display the trends in the psychological profile of individuals 720 over any specified period, including seasonal variations.

Data relating to the dwell time on or the number of revisits to a particular web page as well as meta data relating to places visited and/or purchases made may also be included in an assessment. Tagged data, such as keywords or terms assigned to a piece of information (such as an Internet bookmark, digital image, or a computer file) may also be included.

Although the example relates to the use of indicator collectors for harvesting data relating to emails, it is to be understood that the indicator collectors may collect any suitable data from a data source relating to any suitable indicator(s) of psychological behaviour of the individual, and is not limited to the collection of data relating to emails.

Indicator collectors can also harvest data, which is not directly related to any individual, allowing correlation between apparently unrelated data and changes in individual psychological precursors to be detected.

The invention has been described by way of examples only and it will be appreciated that variation may be made to the embodiments without departing from the scope of the invention.

Data may be obtained from physiological sensors, for example the type that are worn to monitor blood pressure and pulse (wrist or arm band). In our propose system the wearable can be one of many sensors.

Wearable and implanted devices may provide data that can be used to ascertain or support the psychological indicators, or they may provide data that is analysed to extract information about the context in which the individual is operating.

1-76. (canceled)

77. A method for predicting insider threats from an individual comprising the steps of:
harvesting data indicative of psychological precursors of a class of insider threat from one or more data sources in order to derive a psychological profile of an individual;
processing harvested data to provide one or more sets of indicator data, each set of indicator data is associated with, and indicative of, one or more psychological precursors;
mapping the indicator data sets to one or more psychological precursors to derive a probability of the one or more psychological precursors; and
deriving a prediction of the individual being engaged in a specific class of insider threat based on the probabilities of psychological precursors associated with the said class of insider threat.

78. The method according to claim 77, wherein a probability of a psychological precursor (P) of an individual is derived in accordance with:
$${p}_{i} = \frac{{x}_{1} \cdot {w}_{1} + {x}_{2} \cdot {w}_{2} + … + {x}_{n} \cdot {w}_{n}}{{\sum }_{j}^{m} {x}_{j}} = \frac{{\sum }_{i}^{n} {x}_{i} \cdot {w}_{i}}{{\sum }_{j}^{m} {x}_{j}}$$
where pᵢ is an i-th precursor; xᵢ is an i-th indicator; wᵢ is a weight associate to each indicator xᵢ; and Σᵢ^{m}wᵢ=1.

79. The method according to claim 77 includes the step of: deriving a probability of an individual being engaged in a specific class of insider threat in accordance with:
$${a}_{i} = \frac{{p}_{1} \cdot {w}_{1} + {p}_{2} \cdot {w}_{2} + … + {p}_{n} \cdot {w}_{n}}{{\sum }_{j}^{m} {p}_{j}} = \frac{{\sum }_{i}^{n} {p}_{i} \cdot {w}_{i}}{{\sum }_{j}^{m} {x}_{j}}$$
where aᵢ is the i-th activity predictor; is the i-th precursor; wᵢ is the weighting associated with each precursor xᵢ; and Σᵢ^{m}wᵢ=1.

80. The method according to claim 79 wherein a Gaussian distribution is used to determine a baseline of indicator values of behavioral precursors that represent normal behavior of an individual.

81. The method according to claim 79 wherein a quantitative assessment of the behavioral indicators is performed and a statistically significant increase or decrease, from the baseline, is used to provide evidence of one or more psychological precursors, a variance being in accordance with:
$${σ}^{2} = \frac{{\sum }_{i = 1}^{n} {( {x}_{i} - μ )}^{2}}{n}$$
where xᵢ represents each value in a population, μ a mean value of the population, and n is a number of values in the population.

82. The method according to claim 77 wherein the behavioral indicator includes a number of third party electronic interactions, wherein an electronic interaction includes: emails sent, SMS messages sent and instant messages sent.

83. The method according to claim 82 wherein a weighting function is used to modify the behavioral indicator in dependence on a number of distinct recipients of an electronic interaction.

84. The method according to claim 77 wherein the behavioral indicator is obtained by determining a number of software applications in use concurrently and/or open on an individual's workstation or personal computer or laptop; and/or a number of occasions an individual switches from one software application to another software application.

85. The method according to claim 77 wherein the behavioral indicator is a physiological factor, from a group comprising: heart rate, breathing rate, number of keys on a keyboard that are struck in a given time interval, speed of physical movement, number of steps measured by a pedometer, number of direction changes made whilst walking, and number of eye movements measured in a particular time interval.

86. The method according to claim 77, wherein correlation of the psychological profile with another data source is used to provide a prediction of a psychological response of an individual to a future event.

87. The method according to claim 77, wherein a predicted behavior of interest or psychological profile includes communicating to a remote system in order to allow evasive action to be taken.

88. The method according to claim 77 includes the step of: mapping geographic distribution of real-time psychological profiling and prediction data from a network of computers so as to collect raw data from a plurality of geographic locations; and distributing psychological prediction data to a plurality of geographic locations.

89. The method according to claim 77 includes deriving physiological data from an individual and combining the physiological data with one or more precursor data sets, so as to provide an indication of stress of the individual.

90. A method of detecting an insider threat based on email communications, comprising the steps of:
collecting psychological indicators by accessing a plurality of emails sent from a given target user device;
determining a number of aggressive words in each of said plurality of emails;
determining a number of first-person singular pronouns in each of said plurality of emails;
determining a number of second-person pronouns in each of said plurality of emails;
determining a number of first-person plural pronouns in each of said plurality of emails;
determining a number of said plurality of emails sent by said given target user device; and
determining a number of social connections indicated by said plurality of emails sent;
wherein a psychological precursor to a user of said given target user device is obtained based on a correlation of said number of aggressive words, said number of first-person singular pronouns, said number of second-person pronouns, said number of first-person plural pronouns, said number of said plurality of emails sent, and said number of social connections indicated by said plurality of emails.

91. The method of detecting an insider threat based on email communications according to claim 90, wherein:
said plurality of emails sent are periodically collected.

92. The method of detecting an insider threat based on email communications according to claim 90, further comprising:
weighting a psychological indicator determined from said plurality of emails sent.

93. A method of detecting an insider threat based on text message communications, comprising the steps of:
collecting psychological indicators by accessing a plurality of text messages sent from a given target user device;
determining a number of aggressive words in each of said plurality of text messages;
determining a number of first-person singular pronouns in each of said plurality of text messages;
determining a number of second-person pronouns in each of said plurality of text messages;
determining a number of first-person plural pronouns in each of said plurality of text messages;
determining a number of said plurality of text messages sent by said given target user device; and
determining a number of social connections indicated by said plurality of text messages sent;
wherein a psychological precursor to a user of said given target user device is obtained based on a correlation of said number of aggressive words, said number of first-person singular pronouns, said number of second-person pronouns, said number of first-person plural pronouns, said number of said plurality of text messages sent, and said number of social connections indicated by said plurality of text messages.

94. A system for predicting insider threats from one or more individuals, the system comprising:
means for harvesting data indicative of psychological precursors of a class of insider threats from one or more data sources;
a processor for processing the harvested data to provide one or more sets of indicator data associated with one or more individuals;
mapping means for mapping the one or more sets of indicator data to one or more psychological precursor data sets in accordance with a particular psychological precursor;
wherein the processor is operative to generate a prediction of a likelihood of the individual being engaged in a specific class of insider threats based on a psychological profile obtained by combining the psychological precursor data set(s);
wherein a psychological precursor is derived using a psychological precursor detection engine which uses indicator data and derives a value for each indicator data (x) and derives a value for a precursor (p) in accordance with:
$${p}_{i} = \frac{{x}_{1} \cdot {w}_{1} + {x}_{2} \cdot {w}_{2} + … + {x}_{n} \cdot {w}_{n}}{{\sum }_{j}^{m} {x}_{j}} = \frac{{\sum }_{i}^{n} {x}_{i} \cdot {w}_{i}}{{\sum }_{j}^{m} {x}_{j}}$$
where pᵢ is an i-th precursor; xᵢ is an i-th indicator; wᵢ is a weight associate to each indicator xᵢ; and Σᵢ^{m}wᵢ=1 wherein the precursor data set(s) include data indicative of a likelihood of an individual exhibiting a particular psychological precursor; and
means for generating a prediction of the likelihood of the individual being engaged in the class of a specific class of insider threats based on a psychological profile obtained by combining the psychological precursor data set(s).

95. The system according to claim 94 comprising at least one of the following:
mobile devices,
wearable devices and
embedded devices which are adapted to provide physiological data, which physiological data is processed to extract indicators of psychological precursors of an insider threat.

96. The system according to claim 94 comprising:
accelerometers, combined with orientation and means for providing location specific data; and
means for providing background information, about habitual behaviors and behavior styles, which is used to detect behavioral abnormalities.
